(19) United States
(12) Patent Application Publication
(10) Pub. No.: US 2005/0049871 A1
(43) Pub. Date: Mar. 3, 2005

(54) Speaker-dependent recognition of voice command embedded in arbitrary utterance

(76) Inventor: Yifan Gong, Plano, TX (US)

Correspondence Address: TEXAS INSTRUMENTS INCORPORATED, P O BOX 655474, M/S 3999, DALLAS, TX, 75265, US

(21) Appl. No.: 10/648,177

(22) Filed: Aug. 26, 2003

(51) Int. Cl. G10L 15/28

(52) U.S. Cl. 704/255

(57) ABSTRACT

A method of speaker-dependent voice command recognition is provided that includes providing a hybrid of sentence network and Gaussian mixture models with a shared pool of distributions and performing an out-of-vocabulary procedure based on the score difference between a top candidate and background model over the recognized in-vocabulary word. The network is a three section network to represent speech embedded in extra speech where first and last sections are intended to absorb extra- speech and the middle section to match with in-vocabulary speech. An utterance is accepted as containing in-vocabulary word based on a rejection parameter, which has several alternative forms.

### FIELD OF INVENTION

This invention relates to automatic recognition of enrolled voice commands spoken in a sequence of arbitrary words.

### BACKGROUND OF INVENTION

Speaker-dependent (SD) voice commands recognition provides an alternative man-machine interface. See article by C. S. Ramalingam, Y. Gong, L. P. Netsch, W. W. Anderson, J. J. Godfrey, and Y-Hung Kao entitled “Speaker-Dependent Name Dialing in a Car Environment with Out-of-vocabulary Rejection”” in Proceeding of IEEE International Conference on Acoustics, Speech and Signal Processing, pages I-165, Phoenix, March 1999. Typically, it can be used in situations where hands or eyes are occupied. Currently, SD recognition is the most used speech recognition applications on hand-held mobile personal devices, because its operation is by design independent of language, speaker and audio channel.

It is highly desirable to provide an extension of speaker-dependent recognition technology to include word-spotting capability. The word spotting capability system recognizes speaker-specific voice commands embedded in any word strings, including those in foreign languages. For instance, if the command is John Smith then the recognizer is able to recognize the command in utterances “Id like to dial John Smith, please” or “Let's talk to John Smith on his cell phone”.

Existing word spotting systems use a filter model to absorb unwanted words in an utterance. See article by M. G. Rahim and B. H. Juang entitled “Signal Bias Removal for Robust Telephone Speech Recognition in Adverse Environments” I Proceeding of IEEE International Conference on Acoustics, Speech and Signal Processing, Volume 1, pages 445-448, Adelaide, Australia, April 1994. Such a model has to be trained with a large amount of speech, and inherently is language-dependent. Besides, such training inevitably exposes the recognizer to channel mismatch problems. The two shortcomings obviously tarnish the advantages of SD recognizers mentioned above.

The several requirements have to be met are:
1. Rejection capability: It signals if the utterance does not contain any of the enrolled voice commands.
2. No additional training: There is no need for the user to provide voice template for all the words except for the commands.
3. Designed to work for any language: The system is language-independent, and thus requires no change (program, memory) for any languages.
4. Small footprint, low MIPS: No significant memory (search and model storage) and CPU time increase, compared to standard SD recognition.

Most word spotting designs use garbage models to absorb unwanted speech segments. Typically garbage models are trained on a speech database in order to cover all possible acoustic realizations of background noise and extra speech events. Consequently, several issues may limit the use of such systems: The garbage models are trained on a specific speech database, collected using microphones that may be different from the one used on the target device. Such microphone mismatch could decrease the performance of the command recognition. A set of garbage models has to be provided for each language. This is a fatal problem for speaker-dependent command recognition, as it jeopardizes the feature of language-independence.

### SUMMARY OF INVENTION

In accordance with one embodiment of the present invention automatic recognition of enrolled voice commands spoken in a sequence of arbitrary words is provided by a network of shared distributions among enrolled words and garbage words and on a procedure of scoring.

In accordance with one embodiment of the present invention the same set of distributions to model both enrolled words and unwanted words, without collection for unwanted words.

### DESCRIPTION OF DRAWING

FIG. 1 illustrates the tasks description network of a name with three HMMs.

FIG. 2 illustrates quantities involved in utterance rejection.

FIG. 3A is a histogram of the measurements (without extra speech) for rejection decision using accurate formulation (Equation 12).

FIG. 3B is a histogram of the measurements (without extra speech) for rejection decision using simplified formulation (Equation 15).

FIG. 4A is a histogram of the measurement (with extra speech) for rejection decision using accurate formulation ( Equation 12).

FIG. 4B is a histogram of the measurement (with extra speech) for rejection decision using simplified formulation (Equation 15).

FIG. 5A is a histogram of the measurement difference (ρ−\hat{ρ}) obtained from accurate and simplified algorithms for rejection decision without extra speech.

FIG. 5B is a histogram of the measurement difference (ρ−\hat{ρ}) obtained from accurate and simplified algorithms for rejection decision with extra speech.

### DESCRIPTION OF PREFERRED EMBODIMENTS OF THE INVENTION

Two topics on design and implementation are presented. The first one is on the network that describes the recognition task. The second is about the rejection of out-of vocabulary words when word spotting is active.

A WAVES testing database is used, which includes name-dialing and voice command utterances. The two types of utterances that are used are those utterances with extra words and those utterances without extra words. For those utterances without extra words, WAVES name dialing data are used as is. For utterances with extra words, WAVES name dialing data and WAVES command data are used. For each name dialing utterance, two command utterances were selected randomly. A new utterance was then created based on the three utterances, using the pattern: “command+name dialing+command”. The two portions of command are treated as extra words.

We describe a word-spotting algorithm implemented using floating point GMHMM (Gaussian Mixture Hidden Markov Models). The purpose of such an implementation is to investigate possible grammar network configurations, and to establish word spotting performance levels on a speech database. We then present a simplified version of the system, implemented using fixed point version of GMHMM. The goal of the implementation is to maintain language independence and reduce memory occupation.

Floating Point Simulation

Sentence Network and HMM Models

The database allows experiments of speaker-dependent name dialing with 50 names. For each speaker, a unique model is constructed from 50 individual name models. The conversion from 50 individual model sets into a single model set of 50 names requires merging GTMs (Generalized Tying Models) from different model sets. GTMs are a special case of G

For the in-vocabulary words, a block is constructed which allows all 50 words in parallel. To model extra speech, a loop of all English monophones is constructed and placed in front and at the end of the in-vocabulary word block. For illustration, the grammar for speaker s01 m is given in Appendix A. Once compiled the network (.net ) size of the grammar is about 50,143 Bytes.

During the model construction, it is necessary to combine H models built with conventional methods with HMM models trained for each of the speakers. Model conversion tools developed at Texas Instruments were used.

Experimental Results

Four types of evaluation were performed as summarized in Table 1 below.

TABLE 1

| | Models w/o Extra Speech | Models with Extra Speech |
|---|---|---|
| Utterance w/o | 0.05 | 0.10 |
| Extra Speech | | |
| Utterance with | 32.39 | 0.05 |
| Extra Speech | | |

Table 1 shows in classical command recognition (both utterance and models contain no extra speech), the system gives 0.05% Word Error Rate (WER). The performance degrades drastically to 32.39% WER when utterances with extra speech are presented to the recognizer that does not model the extra speech. When both utterance and models contain speech, the recognizer gives the same performance as for the first case. This is an excellent performance. Finally, when models contain extra speech which is not present in the input utterance, the WER is maintained at a very low level. This means that using the network for word spotting will not alter the performance of traditional recognition.

It is concluded that, by using suitable sentence network the word spotting software yields adequate performance in the recognition of utterances either with or without out of vocabulary (OOV) words.

However, the implementation requires substantially larger memory space than the space required by classical SD name dialing without word spotting capability. Also, using a phoneme inventory makes the system dependent on the language in which the phonemes have been trained. Without retraining on additional language, such system is clearly not able to handle other languages.

Fixed Point Implementation

Sentence Network and HMM Models

We observed that the size of such a sentence network for word spotting is about 50 KB. Typically such a large size is not acceptable for handheld devices. In addition, using phone-based HMM models for background speech makes it difficult to port the system for new languages. We would like to determine if frame-based mixture models could maintain the performance and overcome the above problems.

To remove the dependence on language and on channel, we do not use background models that are trained on a speech database and loaded on the device. Instead, the background models are trained on the device, using the mean vectors of all enrolled commands.

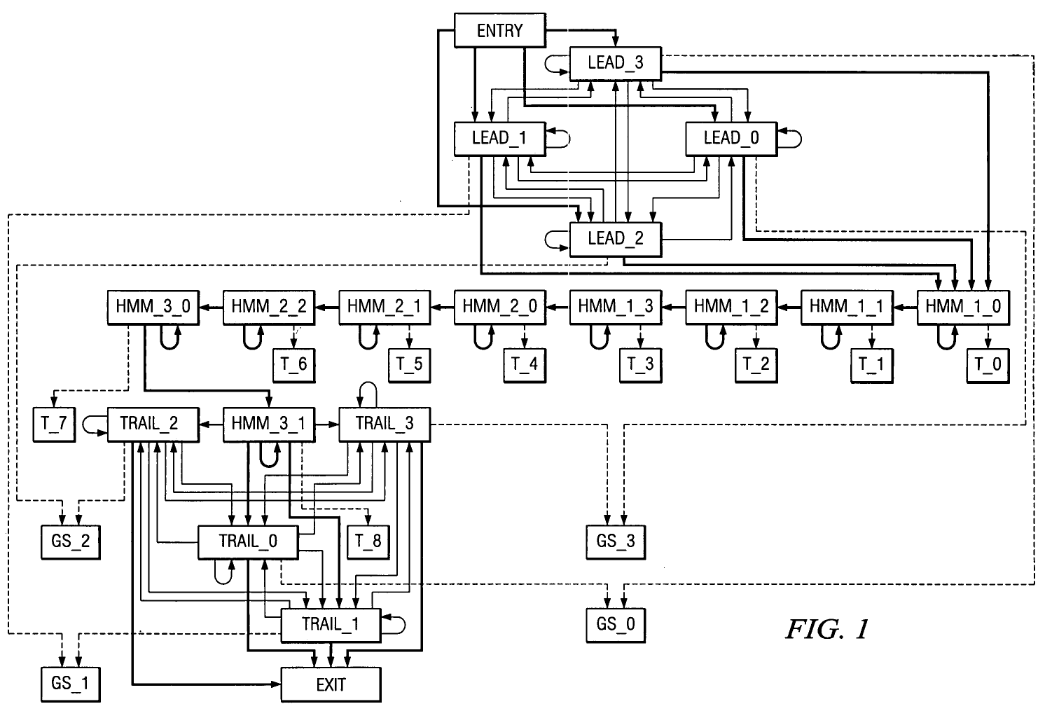

FIG. 1 illustrates a direct implementation of such a sentence network, where a block represents a network node; solid lines represent transition form one node to another, and dashed lines represent the Probability Density Function (PDF) attached to the node.

The network consists of three sections: leading, middle, and trailing sections. The leading and trailing sections are designed to absorb the out-of-vocabulary background speech, and the middle section to absorb the in-vocabulary speech. The middle section consists of nodes, HMMᵢⱼ where HMMᵢⱼ represents the state HMM j of a phone-like unit i. These nodes each have a probability density function (PDF) Tₖ. The leading section has four nodes (LEAD₀ to LEAD₃). From each node a transition is possible to any other of the four nodes, in addition to the first node of the middle section (HMM_{1,0}). The trailing section has the same structure, with nodes (TRAIL₀ to TRAIL₃). It is possible to enter this section only through the last node of the middle section (HMM_{3,1}).

The PDF Tₖ are exclusively used by the HMMs. The nodes of the leading and trailing sections share the PDF GS1. All PDFs above are single Gaussian distributions, with a unique variance shared by all. Therefore, a PDF in FIG. 1 is totally defined by its mean vector.

The PDF Tₖ is trained from the enrollment utterances of a given command. The PDF GS₁ are the centroids of a clustering of the mean vectors of Tk. A clustering is a grouping of a set of vectors into N classes, which maximizes the likelihood of the set of vectors. See article by Y. Linde, A. Buzo and R. M. Gray entitled “An algorithm for the Vector Quantizer Design”, in IEEE Transactions on Communications, COM-28 (1): 84-95, January 1980. Therefore, once N and the vector set are given, GS₁ is known.

This type of network removes the dependence on the language and on the channel, but still uses large memory spaces.

In accordance with an embodiment of the present invention we implement the network using a combination of sentence nodes and mixture models. More specifically, we use a mixture model to represent the leading and trailing sections. Consequently, each of the sections will have only one single node with a mixture of Gaussian distribution as node PDF. This greatly reduces the memory for network storage and for recognition.

Experimental Results

The performance of fixed-point implementation is tested, using the database described previously. We first introduce background model variable mixing coefficient weight into the SD model generation procedure, in order to allow finding the balance between the two types of errors: recognizing background speech as in vocabulary words or recognizing in vocabulary words as background speech. In the case where extra speech is modeled, the balance between WER of utterance with or without extra speech can be adjusted by the mixing weight of the components of the silence mixture, as shown in Table 2.

TABLE 2

| Weight | 1/16 | ½ | 1 |
|---|---|---|---|
| Utterance w/o Extra Speech | 1.66 | 1.06 | 0.86 |
| Utterance with Extra Speech | 0.15 | 0.20 | 0.25 |

Table 2 shows that the balance between the two types of errors changes as a function of the weight. We then fix the weight at 0.5. In applications, this number can be adjusted to provide the best fit to the application requirements.

TABLE 3
Name Dialing Performance as a function of model and utterance types.

| | Models w/o Extra Speech | Models with Extra Speech |
|---|---|---|
| Utterance w/o | 0.10 | 1.06 |
| Extra Speech | | |
| Utterance with | 89.67 | 0.20 |
| Extra Speech | | |

Table 3 shows name-dialing performance with fixed-point implementation as function of model and utterance typed. For silence models, all mixing component weight is set to ½. We observe that the four types of WER shows similar pattern as in Table 1, with one significant difference for the case where models contain extra speech which are not present in the input utterance. For this case, the WER goes from 0.10% in Table 1 to 1.06% in Table 3. We attribute the performance degradation to the fact that the background models (i.e. HMM-based, trained on TIMIT database). Such background models tend to be more aggressive in absorbing in-vocabulary speech frames, thus reducing the chance that such a word is recognized correctly.

Utterance Rejection Algorithm

Formulation

Let m be the variable indicating the type of HMM model.
mε{S,B}
where S represents in-vocabulary speech and B represents background speech.

An utterance containing extra background speech and in-vocabulary speech can be sectioned into three parts: Head (H), Middle (M) and Tail (T). Let s be the section of utterance.
sε{H,M,T}.

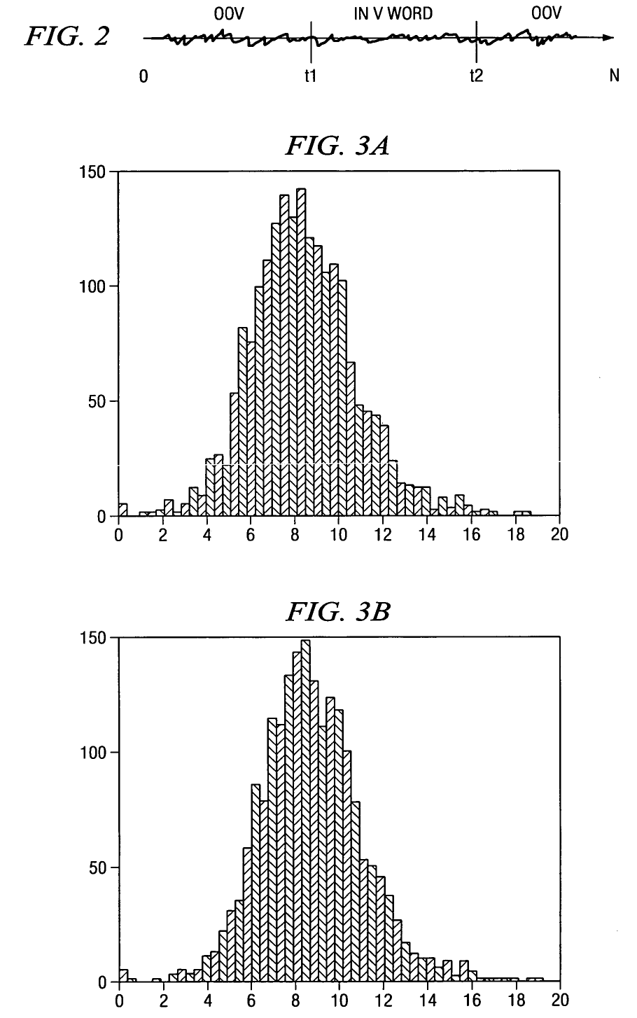

Referring to FIG. 2, we identify:
HΔ[0,t₁) (1)
MΔ[t₁,t₂) (2)
TΔ[t₂, N) (3)

We further introduce δ (m, s), the cumulate log likelihood (score) of model m over the section s of speech.

In the recognition phase, the utterance either contains an enrolled vocabulary (in-vocabulary) word, or does not contain an in-vocabulary word. For the first case, we decode the utterance using HMM models concatenated from {S, B, S}. For the second case, we decode the utterance using HMM models concatenated from {S}.

Rejection Without Extra Speech Modeling

The method is based on the score difference between the top candidate and the background model over the whole utterance. The best score for the models containing an in-vocabulary word:

$${\hat{Δ}}_{S} = {max}_{{t}_{1} , {t}_{2} s . t . \text{:} 0 < {t}_{1} < {t}_{2} < N} δ ( B , [ 0 , {t}_{1} ] ) + δ ( S , [ {t}_{1} , {t}_{2} ] ) + δ ( B , [ {t}_{2} , N ] ) \qquad ( 4 )$$

Since a speech activity detector is used, the N frames of the signal contain mostly speech. The non-speech portions are absorbed by the sections H and T.

The score for the models not containing any in-vocabulary word:
\hat{Δ}_{B}=(B,[0,N]). (5)

A rejection decision is based on the average score over the whole utterance:

$$γ = \frac{{\hat{Δ}}_{S} - {\hat{Δ}}_{B}}{N} \qquad ( 6 )$$

This simple parameter performs adequately for SD name dialing without extra speech.

Rejection With Extra Speech Modeling

Problem With Existing Method

We first analyze the behavior of equation 6 when in-vocabulary is embedded in extra speech (i.e. in word spotting mode).

Let the results of optimization of t₁ and t₂ in equation 4 be \hat{t}₁ and \hat{t}₂. Admitting some loss of optimality, we force the calculation of Δ_{B} on three segments, i.e. [0, \hat{t}₁), [\hat{t}₁,\hat{t}₂), and [\hat{t}₂, N). Equation 6 can be rewritten as:

$$\begin{matrix}γ = \frac{δ ( B , [ 0 , {\hat{t}}_{1} ] ) + δ ( S , [ {\hat{t}}_{1} , {\hat{t}}_{2} ] ) + δ [ B , [ {\hat{t}}_{2} , N ] ) - {\hat{Δ}}_{B}}{N} & ( 7 ) \\ \approx \frac{\begin{matrix}( δ ( B , [ 0 , {\hat{t}}_{1} ] ) + δ ( S , [ {\hat{t}}_{1} , {\hat{t}}_{2} ] ) + δ ( B , [ {\hat{t}}_{2} , N ] ) ) - \\ ( δ ( B , [ 0 , {\hat{t}}_{1} ] ) + δ ( B , [ {\hat{t}}_{1} , {\hat{t}}_{2} ] ) + δ ( B , [ {\hat{t}}_{2} , N ] ) )\end{matrix}}{N} & ( 8 ) \\ = \frac{δ ( S , [ {\hat{t}}_{1} , {\hat{t}}_{2} ] ) - δ ( B , [ {\hat{t}}_{1} , {\hat{t}}_{2} ] )}{N} & ( 9 )\end{matrix}$$

Since N represents the frame number of the whole utterance (including extra-speech), Equation 9 shows that long extra speech duration will cause large N, which forces γ to vanish to zero.

The current OOV rejection procedure, which works perfectly for SD name dialing, performs poorly when applied to name dialing with extra speech. It may totally fail if an enrolled name is embedded in a long utterance of extra speech.

New Method for Rejection

To solve the above problem, typically the calculation and storage of Viterbi scores along the recognition path is necessary. See article by S. Dharanipragada and S. Roukos entitled “A fast Vocabulary Independent Algorithm for Spotting Words in Speech”, in Proceedings of IEEE International Conference on Acoustics, Speech and signal Processing, Volume 1, pages 233-236, Seattle, Wash., USA, May 1998. On small footprint recognizers, such storage increases significantly the memory size. We now describe a new OOV rejection procedure that works based on the score difference between the top candidate and the background model over the recognized in-vocabulary word. The new procedure does not require the storage of Viterbi scores along the recognized path, and therefore does not require increasing the memory in the search process.

As introduced above, the score for the models containing no in-vocabulary words (e.g. background speech model) can be broken into three parts. We force the boundaries of the M-section to be the same as \hat{t}₁ and \hat{t}₂. We have:
Δ_{B}=δ(B,[0, \hat{t}₁])+δ(B, [\hat{t}₁,\hat{t}₂])+δ(B,[\hat{t}₂,N]) (10)

What we want as rejection decision parameter is the average difference in log likelihood over the in-vocabulary word for the duration of the recognized in-vocabulary word:

$$ρ = \frac{δ ( S , [ {\hat{t}}_{1} , {\hat{t}}_{2} ] ) - δ ( B , [ {\hat{t}}_{1} , {\hat{t}}_{2} ] )}{{t}_{2} - {t}_{1}} \qquad ( 11 )$$

As the recognizer does not allow the access of the score δ(S, [\hat{t}₁, \hat{t}₂]), we want to avoid using this quantity directly in the rejection. Using equation 4 and equation 10, we have:

$$ρ = \frac{{\hat{Δ}}_{S} - {Δ}_{B}}{{t}_{2} - {t}_{1}} \qquad ( 12 )$$

The implementation of equation 12 requires calculation of background score on all three sections (H, M, T) of the utterance to obtain
δ(B, [0, \hat{t}₁])δ(B, \hat{t}₁, \hat{t}₂)and(B,[\hat{t}₂, N])

Alternatively, we can relax the constraints on the segments by searching for the best score for the models containing no in-vocabulary word:

$$\begin{matrix}{\hat{Δ}}_{B} = {max}_{{t}_{1} , {t}_{2} s . t . \text{:} 0 < {t}_{1} < {t}_{2} < N} δ ( B , [ 0 , {t}_{1} ] ) + \\ δ ( B , [ {t}_{1} , {t}_{2} ] ) + δ ( B , [ {t}_{2} , N ] )\end{matrix} \qquad ( 13 )$$

From HMM decoding point of view, Equation 13 is equivalent to applying the background model on the whole utterance:
\hat{Δ}_{B}=δ(B, [0, N]) (14)

Consequently, Equation 12 can be replaced by

$$\hat{ρ} = \frac{{\hat{Δ}}_{S} - {\hat{Δ}}_{B}}{{t}_{2} - {t}_{1}} \qquad ( 15 )$$

Thus, the score for rejection is the difference between the score from the best candidate model and the score from the background model, divided by the duration of the assumed in-vocabulary word. Since both scores are calculated on the whole utterance, there is no need to calculate the score over t₂ and t₁.

Experimental Results

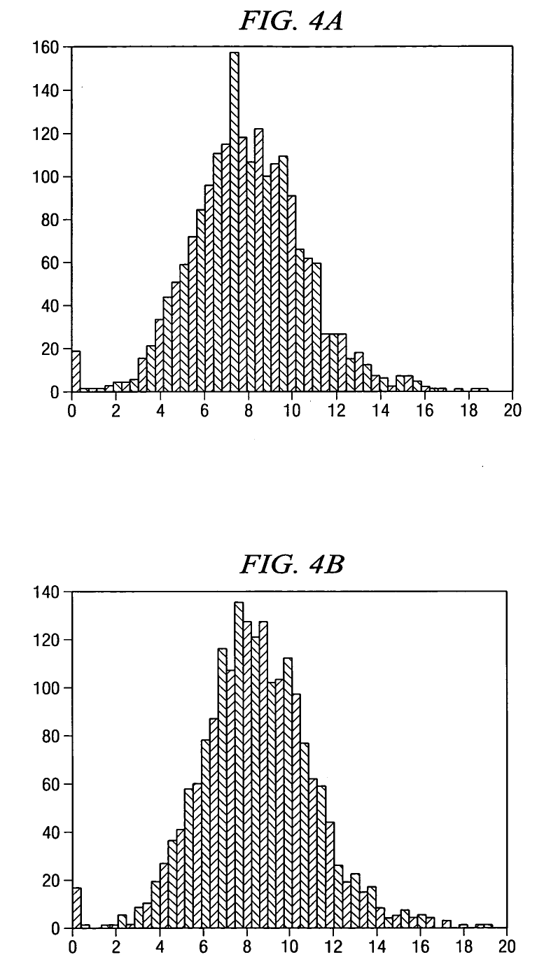

In this section, we experimentally compare the rejection parameters obtained by two different approaches. FIGS. 3A and 3B compare the histograms of the parameters (without extra speech) for rejection decision obtained with equation 12 and equation 15. FIGS. 4A and 4B compare the histograms of the parameter (with extra speech) fro rejection decision obtained with equation 1 and with equation 15. It can be observed that the two equations give comparable results.

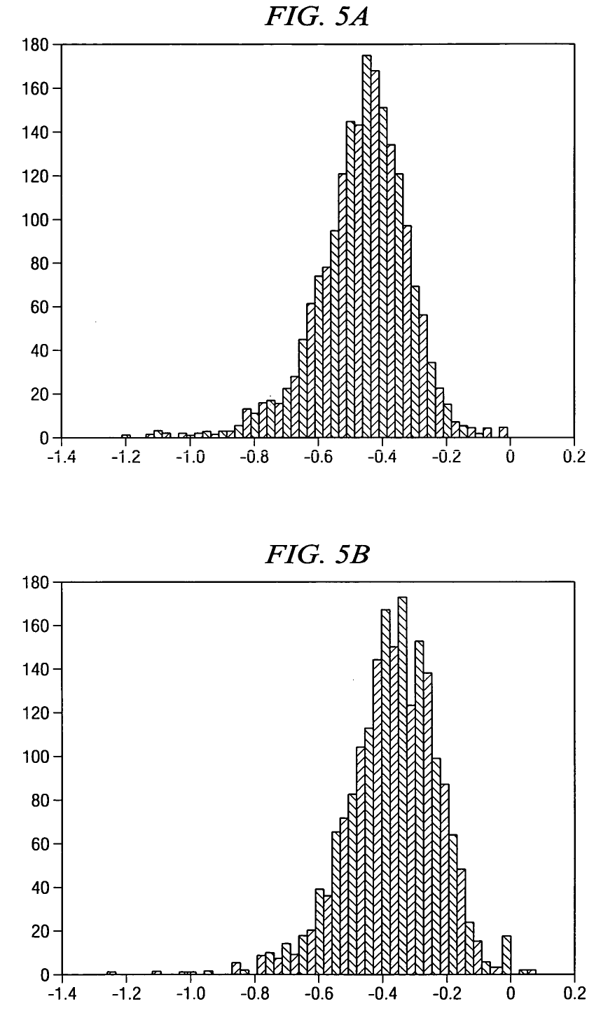

FIGS. 5A and 5B show the histograms of the measurement difference (ρ−\hat{ρ}) obtained from accurate (equation 12) and simplified (equation 15) algorithms for rejection decision. We observe that the difference is actually less than zero. \hat{ρ}

Conclusion

In this application is described a speaker-dependent voice command recognition with word spotting capability. The recognizer is designed specifically to identify speaker-specific voice commands embedded in any word strings, including those in other languages. It rejects an utterance if it does not contain any of the enrolled voice commands.

The recognizer has additional advantages:
1. There is no need for the user to provide a voice-training template for all the words, except for the commands.
2. The recognizer works for any language, since it is designed to be language-dependent.
3. Compared to standard SD recognition, the new recognizer does not need significant memory (search and model storage) and CPU time increase.

The design is based on two key new teachings. The first is a hybrid of sentence network and Gaussian mixture models, with shared pool of distributions. The structure allows accurate SD word spotting without the need of pre-training background models. The second is an OOV rejection procedure that works based on the score difference between the top candidate and the background model over the recognized in-vocabulary word. The new procedure does not require the storage of Viterbi scores along the recognized path, and therefore does not require increasing the memory in the search process.

1. A method of speaker-dependent voice command recognition comprising the steps of:
providing a hybrid of sentence network and Gaussian mixture models with a shared pool of distributions; and
performing an out-of-vocabulary procedure based on the score difference between a top candidate and background model over the recognized in-vocabulary word.

2. The method of claim 1 wherein said network is a three section network to represent speech embedded in extra speech where first and last sections are intended to absorb extra- speech and the middle section to match with in-vocabulary speech.

3. The method of claim 2 wherein the first and last sections of the network comprise fully interconnected nodes and the second section comprises nodes sequentially (left-to-right) connected.

4. The method of claim 3 wherein to each of the nodes is attached a power density function (PDF) and the PDF attached to the first and last sections are shared by the nodes belonging to the two sections.

5. The method of claim 4 wherein the PDFs in the network are modeled as single Gaussian distributions with a unique variance shared by all nodes of the network

6. The method of claim 5 wherein the PDFs of the second section are trained from the enrollment utterances of a given command.

7. The method of claim 6 wherein the PDF of the first and last sections are the centroids of a clustering of the mean vectors of the PDFs of the second section.

8. The method of claim 7 wherein transition from one node to another is attached to a weight, and the balance between recognition errors of utterance with or without extra speech is controlled by adjusting the weights of the components of the nodes of the first and last sections.

9. The method of claim 8 wherein an utterance is accepted as containing in-vocabulary word based on a rejection parameter, which has several alternative forms.

10. The method of claim 9 wherein the rejection parameter is calculated using the following steps:
calculating, the best possible log-likelihood using a three section network model,
locating the first and last frame of the in-vocabulary word,
extracting the cumulate log likelihood from the first to the last frame of the in-vocabulary word,
calculating the best possible log-likelihood using a network model representing only the extra-speech from the first to the last frame of the in-vocabulary word and
dividing the difference of the above two values of log likelihood by the number of frames of the in-vocabulary word.

11. The method of claim 9 wherein the rejection parameter is calculated by the following steps:
calculating a, the best possible log-likelihood using a three section network model; locating the first and last frame of the in-vocabulary word;
calculating the best possible log-likelihood using a network model representing only the extra-speech for three sections:
from beginning of the utterance to first frame of the in-vocabulary word,
from the first to last frame of the in-vocabulary word,
from the last frame of the in-vocabulary word to the end of utterance;
subtracting from a the above three values; and
dividing the resulting value by number of frames of the in-vocabulary word.

12. The method of claim 9 wherein the rejection parameter is calculated by the following steps:
calculating the best possible log-likelihood using a three section network model;
locating the first and last frame of the in-vocabulary word;
calculating the best possible log-likelihood using a network model representing only the extra-speech over the whole utterance; and
dividing the difference of the above two values of log likelihood by the number of frames of the in-vocabulary word.
